(19) United States
(12) Patent Application Publication
(10) Pub. No.: US 2010/0092621 A1
(43) Pub. Date: Apr. 15, 2010

(54) MULTI-LAYER PLASTIC CONTAINER FOR NON-OILY CONTENTS

(75) Inventors: Yosuke Akutsu, Kanagawa (JP); Atsushi Kikuchi, Kanagawa (JP)

Correspondence Address: GREENBLUM & BERNSTEIN, P.L.C., 1950 ROLAND CLARKE PLACE, RESTON, VA, 20191, US

(73) Assignee: TOYO SEIKAN KAISHA, LTD., Tokyo (JP)

(21) Appl. No.: 12/529,507

(22) PCT Filed: Mar. 12, 2008
(86) PCT No.: PCT/JP2008/054455

§ 371 Date: Sep. 1, 2009

(30) Foreign Application Priority Data
Mar. 15, 2007 (JP) 2007-066491

(51) Int. Cl. B65D 85/72; B32B 1/02

(52) U.S. Cl. 426/106; 428/35.7

(57) ABSTRACT

[Problem] To provide a polyethylene container which enables a non-oily viscous content such as ketchup or the like to favorably run down when the container is inverted.

[Means for Solution] A polyethylene container having at least a polyethylene resin layer on the inner surface thereof, wherein the polyethylene resin layer on the inner surface of the container contains an aliphatic amide in an amount of not less than 500 ppm but less than 4000 ppm.

### TECHNICAL FIELD

This invention relates to a multi-layer plastic container applied to non-oily contents and, particularly, viscous and non-oily contents (e.g., ketchups).

### BACKGROUND ART

A plastic container is easy to form and can be inexpensively produced. Upon employing a multi-layer structure, further, a variety of properties can be easily improved paving the way for using the plastic containers for a wide range of applications. For example, a multi-layer plastic container of which the inner wall surface is formed by a polyolefin resin layer such as of polyethylene, has been used as a container for containing viscous and slurry-like or paste-like contents.

The plastic container containing a viscous content is, in many cases, preserved in an inverted state so that the viscous content filled therein can be quickly discharged or can be used up to the last drip without being left in the container. It is, therefore, desired that when the container is inverted, the content which, for example, may be viscous quickly falls down without staying on the inner wall surface of the container.

Various plastic containers have been proposed suppressing the adhesion of the contents on the inner wall surfaces of the containers. For example, patent document 1 is proposing a multi-layer polyethylene container used for containing a shampoo or a liquid detergent which chiefly comprises a surfactant, wherein a polyethylene layer forming the inner surface is blended with 4000 ppm or more of erucic amide or with 1 to 5% by weight of silicone oil as an agent for preventing the adhesion on the inner surface of the container.

As will be understood from the proposal of the above patent document 1, study for enabling nearly the whole amount of content to be quickly discharged out of the container without adhering on the wall surfaces of the container, has been conducted much concerning the oily and sticky contents such as shampoos and liquid detergents, but has not been much conducted concerning non-oily substances such as ketchups which are viscous but are not oily or sticky. For example, a patent document 2 proposes a polyolefin resin bottle for containing such foods as ketchup or mayonnaise, the resin layer comprising the polyolefin blended with two or more kinds of fatty acid amides. According to this proposal, however, the two kinds of fatty acid amides are added to the surface layer to impart slipping property to the bottle to thereby improve anti-blocking property of the bottle and to prevent inconvenience caused by the contact among the bottles or by the contact of the bottle with any other member on the bottle production line which, however, is not to prevent the content from adhering on the inner wall surfaces of the container.

Patent document 1: JP-A-6-99481

Patent document 2: Japanese Patent No. 2627127

### DISCLOSURE OF THE INVENTION

### Problems to be Solved by the Invention

It is, therefore, an object of the present invention to provide a multi-layer plastic container for non-oily contents, which, when inverted, enables a non-oily viscous content to favorably fall down even when the content is hot-filled therein, and which can be produced inexpensively and easily.

Another object of the present invention is to provide a packing body which does not permit properties to be impaired by heat despite the non-oily content is hot-filled therein, and, when inverted, permits the content to fall down excellently.

### Means for Solving the Problems

According to the present invention, there is provided a multi-layer plastic container for a non-oily content having at least a polyolefin resin layer on an inner surface thereof and for being filled with the non-oily content, wherein the polyolefin resin layer on the inner surface of the container contains an aliphatic amide in an amount of not less than 500 ppm but less than 4000 ppm.

In the multi-layer plastic container of the present invention, favorable embodiments are as described below.

(1) At least part of the aliphatic amide is an unsaturated aliphatic amide;
(2) The unsaturated aliphatic amide has carbons in a number in a range of 14 to 24;
(3) The unsaturated aliphatic amide is an oleic amide;
(4) The polyolefin resin layer is, further, blended with an organic peroxide;
(5) The polyolefin resin layer is blended with an unsaturated aliphatic amide and a saturated aliphatic amide as the aliphatic amide;
(6) The unsaturated aliphatic amide and the saturated aliphatic amide are blended at a weight ratio of 1:0.1 to 1:4;
(7) At least two kinds of amides of oleic amide and erucic amide are contained as the unsaturated aliphatic amide;
(8) The saturated aliphatic amide is a stearic acid amide; and
(9) The polyolefin resin layer on the inner surface of the container is a polyethylene resin layer.

According to the present invention, there is further provided a packing container wherein the multi-layer plastic container is hot-filled with a non-oily content.

In the above packing body, it is desired that:

(1) The non-oily content is a viscous food; and
(2) The viscous food is ketchup.

The multi-layer plastic container of the present invention, when inverted, permits a non-oily content to excellently fall down owing to the fact that a polyolefin resin layer (e.g., polyethylene resin layer) present on the inner surface of the container is blended with an unsaturated aliphatic amide such as an aliphatic amide and, particularly, an oleic acid in an amount of not less than 500 ppm but less than 4000 ppm. Concretely, when preserved in an inverted state, a viscous non-oily content as represented by ketchup quickly falls down without staying on the inner wall surfaces of the container. As a result, the viscous non-oily content can be thoroughly discharged out of the container without being left on the bottom of the container.

According to Experiment 1 appearing later, for example, a substrate was made from a polyethylene resin blended with various additives, a ketchup of a given amount was placed on the substrate which was, then, tilted at 85 degrees to measure the speed of the ketchup that is rolling down (see Experiment 1 for detailed conditions). The faster the speed of roll down, the more excellent the fall-down performance when inverted.

Table 1 showing the experimental results (see Experiment 1 appearing later) tells that when a slip additive as represented by a higher fatty acid or a salt thereof, or a fluidized paraffin or a paraffin wax is blended, the roll-down speed is only slightly faster than that of a blank polyethylene resin substrate blended with quite no additive, whereas the polyethylene resin substrate blended with the aliphatic amide according to the present invention features a very greatly increased roll-down speed. It will be learned from the above Experimental results that the multi-layer plastic container of the present invention enables even the non-oily content and, particularly, the viscous content to excellently fall down when inverted.

As will be learned from the above Experiment 1, further, the present invention uses an aliphatic amide and, particularly, an unsaturated aliphatic amide to greatly improve the inverted fall-down performance. When the stearic acid amide is used, for example, the roll-down speed of the ketchup is 1.9 mm/min., whereas when the unsaturated aliphatic amide is used, the roll-down speed of the ketchup is greater than 2 mm/min., and the roll-down speed exceeds 20 mm/min. when the oleic amide is used. It is, therefore, learned that what most contributes to the inverted fall-down performance is the aliphatic amide and, particularly, the unsaturated aliphatic amide. Among them, the oleic amide helps attain the greatest inverted fall-down performance.

In the present invention, though the reason has not been clarified yet why the inverted fall-down performance is improved by the aliphatic amide that is blended and, particularly, the inverted fall-down performance is markedly improved when the unsaturated aliphatic amide is blended, the present inventors presume as described below.

The aliphatic amide molecules are amphipatic molecules having a polar group (amide group) and a nonpolar group (hydrocarbon group), and, particularly, in which a hydrogen bond can be formed between an oxygen atom and a hydrogen atom in the amide group. As schematically illustrated in FIG. 1, therefore, it is considered that the aliphatic amide molecules bleeding on the surface of the polyethylene resin layer form a multiplicity of molecular layers due to an attractive force between the polar groups produced by the force of hydrogen bond and an attractive force produced by the Van der Waals force (considerably weaker than the force of hydrogen force) acting between the nonpolar groups. Therefore, the viscous content rolls down on the multiplicity of molecular layers. In this case, the non-oily content has a high degree of affinity to the polar group of the aliphatic amide. While the content is rolling down, therefore, cleavage occurs between the nonpolar groups having a weak bonding force in the multiplicity of molecular layers. Namely, in the present invention, cleavage occurs in the multiplicity of molecular layers of the aliphatic amide, and the non-oily content rolls down while peeling off the aliphatic amide molecules in the upper part of the multiplicity of molecular layers. As a result, it is believed that the roll-down speed is large and, hence, excellent inverted fall-down performance is exhibited. For example, none of aliphatic acid such as stearic acid or paraffin wax forms such a multiplicity of molecular layers or develops cleavage. Therefore, the roll-down speed is slow and the inverted fall-down performance is not satisfactory.

Further, the unsaturated aliphatic amide has an unsaturated bond in the hydrocarbon chain. When the unsaturated aliphatic amide bleeds on the surface of the polyethylene resin layer to form a multiplicity of molecular layers, therefore, its degree of molecular order is low exhibiting a high molecular motion as compared to the saturated aliphatic amide without unsaturated bond. When the non-oily content rolls down, therefore, cleavage easily occurs between the nonpolar groups. As a result, there are exhibited a very fast roll-down speed and a very excellent inverted fall-down performance. In fact, as described above, the roll-down speed is about 1.9 mm/min. when the stearic acid amide is added whereas the roll-down speed is as very fast as about 20 mm/min. when the oleic amide having the same number of carbons is added.

Here, when the multi-layer plastic container having the inner polyolefin resin layer blended with the aliphatic amide is hot-filled with the non-oily content, the above-mentioned inverted fall-down performance is not often exhibited to a sufficient degree. According to, for example, Experiment 3 appearing later, sample substrates blended with the unsaturated aliphatic amide and the saturated aliphatic amide were once held in a ketchup maintained at 85° C. for 5 seconds, taken out therefrom, and were returned back to room temperature. Thereafter, the ketchup adhered on the surface of the substrate was washed away with ion-exchanged water, and the substrates were dried to measure again the roll-down speed at room temperature (23° C.) in the same manner as described above. According to the experimental results, it was learned that the roll-down speed has greatly decreased when the unsaturated aliphatic amide was used and, particularly, when the oleic amide was used.

Among various slip additives, the unsaturated aliphatic amide, in particular, forms a multiplicity of molecular layers as shown in FIG. 1 and, therefore, exhibits excellent inverted fall-down performance. However, when the container is subjected to the thermal hysteresis due to hot-filing at, for example, 80° C. or higher, it is considered that the multiplicity of molecular layers are destroyed or removed and, as a result, the inverted fall-down performance is impaired. That is, the multiplicity of molecular structures are destroyed or removed due to the thermal hysteresis; i.e., the multiplicity of molecular layer structures such as of the unsaturated aliphatic amide are made present on the inner surfaces of the container in a state which is not enough for exhibiting a high inverted fall-down performance.

That is, a drop in the inverted fall-down performance due to the thermal hysteresis tells that the fall-down performance is not generated by simply bleeding of the sip additive such as aliphatic amide on the surface of the plastic molded body but is generated by the formation of the multiplicity of molecular structures as shown in FIG. 1. If the fall-down performance is generated by simply being bled on the surface, then a high inverted fall-down performance would be attained even with a slip additive other than the aliphatic amide. Besides, even if subjected to the thermal hysteresis, after returned to room temperature, the properties of the component that is bled will be little different from the properties of before being subjected to the thermal hysteresis. Namely, it is not considered that the inverted fall-down property decreases through the thermal hysteresis.

According to the present invention, however, a decrease in the inverted fall-down performance is avoided by using the unsaturated aliphatic amide and the saturated aliphatic amide in combination as the aliphatic amide. As demonstrated in Experiments appearing later, upon using the unsaturated aliphatic amide and the saturated aliphatic amide in combination, the roll-down speed of when, for example, the oleic amide is used becomes nearly the same as that of when not subjected to the thermal hysteresis. As a result, excellent inverted fall-down performance can be realized even when the container is hot-filled with the non-oily content.

The reason why use of the unsaturated aliphatic amide and the saturated aliphatic amide in combination effectively prevents the inverted fall-down performance from being decreased by the thermal hysteresis, is presumably that the saturated aliphatic amide itself works to easily form a multiplicity of molecular layer structures, has a melting point higher than that of the unsaturated aliphatic amide and, hence, forms a multiplicity of molecular layer structures together with the unsaturated aliphatic amide and, further, that, when subjected to the thermal hysteresis, works to suppress thermal motion of the unsaturated aliphatic amide. As a result, it is presumed that the multiplicity of molecular layer structures are not destroyed or removed by the thermal hysteresis, but are maintained.

According to the present invention, further, an organic peroxide is added together with the aliphatic amide making it possible to stably maintain not only the inverted fall-down performance but also excellent inverted fall-down performance even after subjected to the thermal hysteresis of hot-filling the content. That is, the multiplicity of molecular layers of the aliphatic amide has poor adhesiveness to the surface of the polyolefin resin layer and may, therefore, be removed from the surface of the polyolefin resin layer due to external force caused by vibration or thermal hysteresis. Upon being blended with the organic peroxide, the organic peroxide reacts with the aliphatic amide and with the polyolefin resin which is the base material. As a result, the aliphatic amide that is bleeding is firmly fixed to the surface of the polyolefin resin layer. This anchoring effect stably maintains excellent inverted fall-down performance even after subjected to the thermal hysteresis of hot-filling.

For example, Experiment 6 described later holds the polyethylene resin substrate in water at 25° C. and measures the roll-down speed of the ketchup in the same manner as in Experiment 1 after having effected the treatment with ultrasonic waves for one minute. According to this Experiment, the roll-down speed apparently decreases after the treatment with ultrasonic waves when the polyethylene resin substrate is blended with the aliphatic amide only. However, a decrease in the roll-down speed is not at all recognized when the polyethylene resin substrate is blended with the organic peroxide.

Similarly, Experiment 7 described later dips the polyethylene resin substrate in hot water of 85° C. for 30 seconds and measures the roll-down speed of the ketchup in the same manner as Example 1. According to this Experiment, the roll-down speed apparently decreases after dipped in hot water when the polyethylene resin substrate is blended with the aliphatic amide only. Like in Experiment 6, however, a decrease in the roll-down speed is not at all recognized when the polyethylene resin substrate is blended with the organic peroxide.

As described above, the polyethylene container of the present invention which also uses the organic peroxide produces excellent inverted fall-down performance owing to the anchoring effect stemming from the organic peroxide. In particular, since a viscous food such as ketchup is filled in the container while it is hot, the inverted fall-down performance that lasts long offers a very great advantage.

### BRIEF DESCRIPTION OF THE DRAWINGS

FIG. 1 is a diagram illustrating a principle of the present invention.

FIG. 2 is a view showing a polyethylene container of the present invention together with a cap.

FIG. 3 is a diagram showing a relationship between the amount of adding an aliphatic amide and the roll-down speed of ketchup.

FIG. 4 is a graph showing experimental results (experimental results of Table 3) in Experiment 4.

FIG. 5 is a graph showing experimental results (experimental results of Table 4) in Experiment 5.

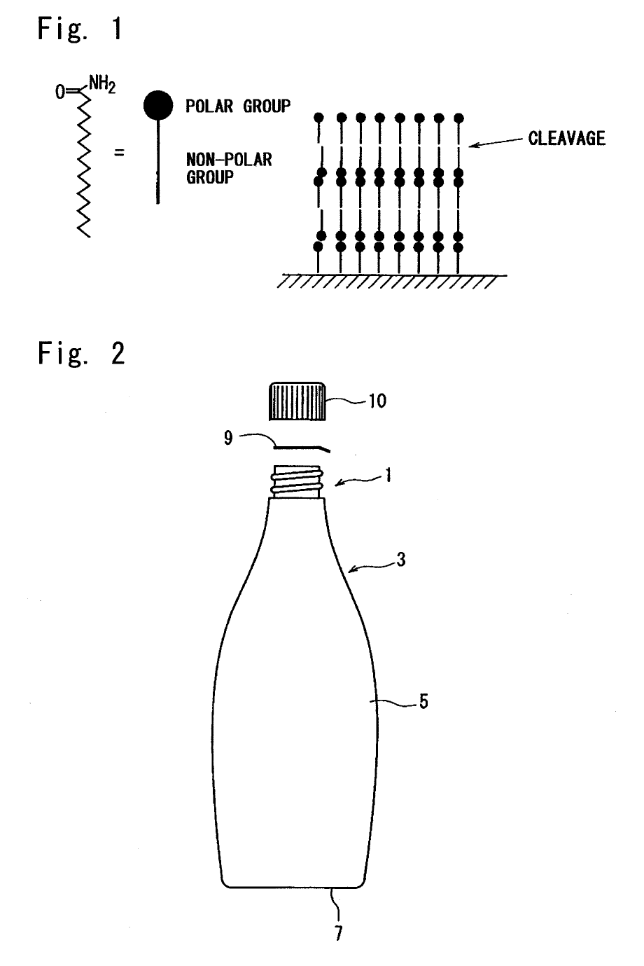

### THE BEST MODE OF THE INVENTION

### Non-Oily Contents

The multi-layer plastic container of the present invention can be used for containing non-oily contents. Though not limited thereto only, a representative example of the non-oily content will be ketchup among other examples such as various sauces and liquid pastes. Among such non-oily contents, viscous paste-like or slurry-like contents (e.g., having a viscosity at 25° C. of not less than 100 cps) are, particularly, preferred. This is because such viscous contents are desired to be discharged out of the container without staying on the container walls. Among these viscous non-oily contents, further, the present invention is preferably applied to such foods as ketchups and sauces. These foods are hot-filled (usually at 80 to 90° C.) for also the purpose of sterilization and, as described above, the polyethylene container of the present invention is capable of maintaining excellent inverted content fall-down performance even after subjected to the thermal hysteresis.

### <Container Structure>

In the multi-layer plastic container of the invention to be filled with the above non-oily content, the inner layer forming the inner surface of the container comprises a polyolefin resin layer. That is, the polyolefin resin has excellent moisture resistance. Upon forming the inner layer of the container by using the polyolefin resin, therefore, water content contained in the non-oily content can be stably maintained so will not to be released for extended periods of time preventing a drop in the quality of the non-oily content, effectively avoiding a decrease in the properties of the container caused by swelling due to water and, besides, offering advantage from the standpoint of cost.

As the polyolefin resin, though there is no particular limitation, there can be exemplified low-density polyethylene, straight chain low-density polyethylene, intermediate- or high-density polyethylene, polypropylene, poly 1-butene and poly 4-methyl-1-pentene. There can be used a random or block copolymer of α-olefins, such as ethylene, propylene, 1-butene or 4-methyl-1-pentene, as a matter of course. The above polyolefin resin has a melt flow rate (MFR, JIS K-6728) which, usually, lies in a range of about 0.1 to about 3 g/10 min. The polyolefin resin that is particularly preferably used in the present invention is polyethylene or polypropylene, and polyethylene is best suited.

In the plastic container of the present invention, the polyolefin resin layer (inner layer) on the inner surface of the container is blended with the aliphatic amide to improve the inverted fall-down performance. On the outer side of the polyolefin resin inner layer, there are provided various kinds of known resin layers to constitute a multi-layer structure. Upon forming the multi-layer structure, the aliphatic amide added to the polyolefin resin layer does not bleed on the outer surface of the container but selectively bleeds on the inner surface of the container. As a result, a multiplicity of molecular layers is formed on the inner surface of the container to exhibit a sufficient degree of inverted fall-down performance.

A representative example of the multi-layer structure will be a 5-layer structure comprising inner surface layer (polyolefin resin layer)/adhesive layer/oxygen-barrier layer/adhesive layer/outer surface layer. In the above layer structure, the adhesive layer is formed from an adhesive resin such as an acid-modified olefin resin, and the oxygen-barrier layer is formed from an oxygen-barrier resin such as an ethylene/vinyl alcohol copolymer. Further, the outer surface layer is, generally, formed by using the same polyolefin resin as the inner surface layer, but may also be formed by using a polyester resin such as of the other thermoplastic resin layer, e.g., polyethylene terephthalate. In the present invention, the aliphatic amide may be added to the inner surface layer only and does not have to be added to other layers. What contribute to improving the inverted fall-down performance are unsaturated and saturated aliphatic amides only that are added to the inner surface layer. Those added to other layers do not contribute to improving the inverted fall-down performance but simply result in an increase in the cost.

Further, the multi-layer structure is not limited to the above 5-layer structure only, but may be a structure having a further increased number of outer surface layers by using, for example, an oxygen-barrier layer and an adhesive layer. Moreover, the inner surface layer blended with the unsaturated and saturated aliphatic amides may be formed by using a low-density polyethylene or a linear low-density polyethylene to realize a 2-layer structure provided with a high-density polyethylene layer adapted for being printed on the outer surface side.

In the present invention, the layers constituting the container wall may have thicknesses adapted to their functions. For example, the inner surface layer blended with the aliphatic amide should have a thickness of at least not less than 50 μm. If the thickness is too small, the amide does not bleed in amounts sufficient for forming a multiplicity of layers and, as a result, the inverted fall-down performance becomes unsatisfactory. Further, the adhesive layer may have a thickness enough for maintaining a sufficiently large adhesive force, and the oxygen-barrier layer should have a thickness enough for exhibiting favorable oxygen-barrier property while effectively preventing the content from being deteriorated by oxygen that permeates through.

The multi-layer plastic container of the present invention having the above layer constitution can be produced by using resins (or resin compositions) for constituting the layers, extruding a molten parison through a multi-layer die head by co-extrusion molding, forming a test tube-like preform for forming a container by effecting the known direct-blow molding or co-injection molding, and blow-molding the preform in a customary manner.

The thus molded multi-layer plastic container has the shape of a bottle as shown in, for example, FIG. 2, including a neck portion 1 with a screw, a body portion 5 continuous to the neck portion through a shoulder portion 3, and a bottom portion 7 closing the lower end of the body portion. After the container is filled with the non-oily content, the opening portion at the upper end of the neck portion 1 is heat-sealed with a metal foil 9 such as an aluminum foil, and a predetermined cap 10 is fitted thereto. Thus, the container can be used as a packing container. To use the packing container, the cap 10 is opened, the metal foil 9 applied with a sealing member is peeled off, and the container is tilted or inverted to take out the content.

The multi-layer plastic container of the present invention is not limited to those of the shape of a bottle as described above but may also be those of the shape of a cup by using, for example, a sheet- or dish-like preform for container, and molding the preform by, for example, a plug-assisted molding. Such containers are not tilted to take out the non-oily content, but permit the non-oily content to be taken out without being left in the container since the container wall effectively suppresses the adhesion of the non-oily content thus effectively applying the present invention.

### <Kinds of Amide and Blending Amounts>

In the plastic container of the above-mentioned multi-layer structure of the present invention, the polyolefin resin layer positioned on at least the inner surface of the container is blended with the aliphatic amide to thereby improve the inverted fall-down performance of the non-oily content. Therefore, even a viscous content can be quickly and thoroughly discharged out of the container without staying on the inner surface of the container wall.

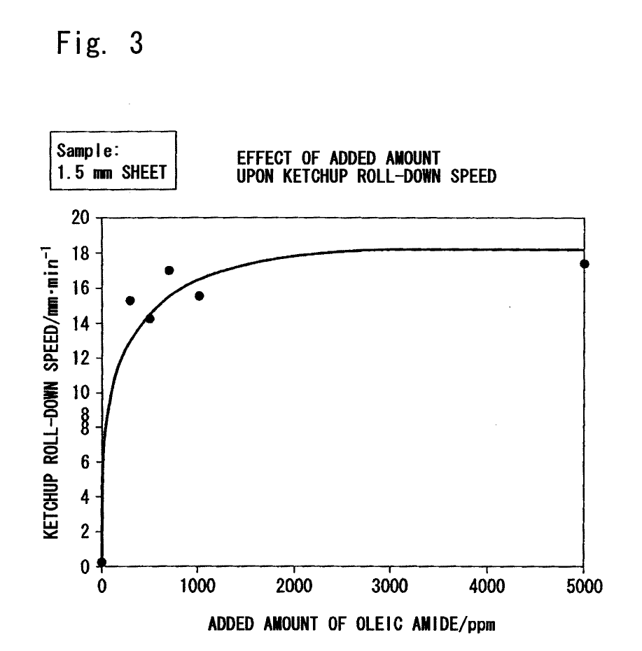

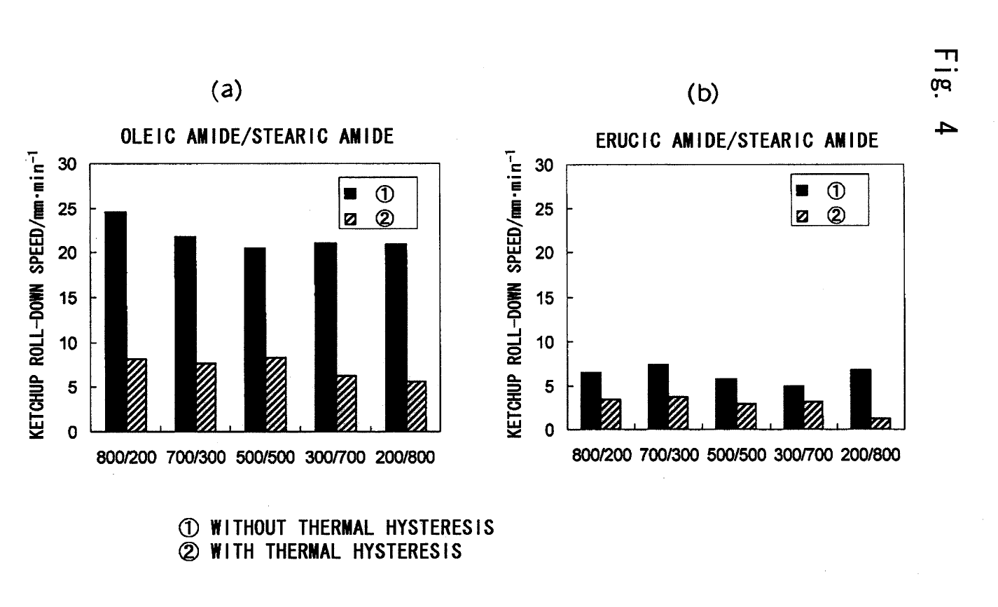

In the present invention, the aliphatic amide should be added to the polyolefin resin layer in an amount of not less than 500 ppm but less than 4000 ppm and, further preferably, in an amount of not less than 500 ppm but not more than 3000 ppm. That is, as will be understood from FIG. 3 (experimental results of Experiment 2) showing a relationship between the amount of blending the aliphatic amide (oleic amide) and the roll-down speed, when the amount of blending the aliphatic amide is smaller than the above range, the amount of bleeding is small, and the multiplicity of molecular layers are not formed to a sufficient degree. Therefore, the roll-down speed is small and the inverted fall-down performance is not satisfactory. Referring to FIG. 3, on the other hand, the roll-down speed reaches saturation at about 3000 ppm. Even if the aliphatic amide is added in an amount of not smaller than, for example, 4000 ppm, therefore, the roll-down speed is not improved any more. That is, the aliphatic amide may be added in an amount enough for forming a multiplicity of molecular layers to a degree that contributes to improving the roll-down speed. Adding the aliphatic amide in amounts larger than the required amount is technically meaningless and rather pushes up the cost, permits the aliphatic amide that is bleeding to be easily removed from the inner wall surface of the container and deteriorates the flavor-retaining property particularly when the content is a food. From the standpoint of durability of the inverted fall-down performance, further, it is desired that the aliphatic amide is blended in an amount of not less than 500 ppm. That is, when the aliphatic amide is added in an amount of not less than 500 ppm, the multiplicity of molecular layers can be maintained in a sufficiently large amount on the surface even when the aliphatic amide is partly removed from the surface of the polyethylene resin layer due to external physical force such as thermal hysteresis or vibration.

The above patent document 1 proposes blending the erucic amide in a large amount in excess of 4000 ppm in order to prevent the content from adhering on the inner surface of the polyethylene container. According to this technology, however, the contents are limited to those substances that chiefly contain a surfactant, such as shampoo and the like, and it is considered that the erucic amide must be added in amounts larger than the amounts used in the present invention. That is, the patent document 1 is based on a principle in that the content containing a surfactant adheres little to the erucic amide and, therefore, simply utilizes the non-affinity between the content and the erucic amide, which is altogether different from the principle of the present invention which utilizes the cleavage in the multiplicity of molecular layers.

In the present invention, various aliphatic amides can be used and, at least, an unsaturated aliphatic amide can be preferably used. As the unsaturated aliphatic amide, there can be exemplified acrylamide, methacrylamide, crotonamide, isocrotonamide, undecylenic acid amide, cetoleic acid amide, oleic acid amide, erucic acid amide, ethylenebisoleic amide, oleylpalmitamide, stearylerucamide, linolic acid amide, linoleic acid amide, linolenic acid amide, and arachidonic acid amide, which can be used in a single kind or in a combination of two or more kinds. To form a multiplicity of molecular layers having highly cleaving property, further, the aliphatic amide should have a suitable degree of chain length. From this point of view, it is desired to use those having carbons in a number in a range of 14 to 24, such as cetoleic acid amide, oleic acid amide, erucic acid amide, linoleic acid amide, linolenic acid amide and arachidonic acid amide. Among them, the oleic acid amide exhibits the highest inverted fall-down performance.

In the present invention, further, it is desired to add the saturated aliphatic amide in addition to the above-mentioned unsaturated aliphatic amide from the standpoint of effectively avoiding a decrease in the inverted fall-down performance caused thermal hysteresis. When the saturated aliphatic amide is used in combination, in particular, it is desired to use an oleic acid amide and an erucic amide in combination as the unsaturated aliphatic amide. That is, as will be learned from Experiments appearing later, use of the saturated aliphatic amide in combination with the oleic acid amide and the erucic amide makes it possible to most effectively avoid a decrease in the inverted fall-down performance caused by thermal hysteresis. This is presumably due to that the erucic amide is highly compatible with the saturated aliphatic amide (e.g., stearic acid amide) used in combination with the unsaturated aliphatic amide, contributing to enhancing the interaction between the molecules of the saturated aliphatic amide distributed in the multiplicity of molecular layers formed by the oleic amide and the molecules of the oleic amide and, therefore, working to most effectively suppress the breakdown of the multiplicity of molecular layers caused by thermal hysteresis.

In this case, it is desired to use the oleic amide and the erucic amide at a weight ratio of 9:1 to 1:9 and, particularly, 8:2 to 2:8.

As the saturated aliphatic amide to be used in combination with the unsaturated aliphatic amide, there can be exemplified butylamide, hexylamide, decylamide, lauric acid amide, myristic acid amide, palmitic acid amide and stearic acid amide, which may be used in a single kind or in two or more kinds in combination. Among these saturated aliphatic amides, the stearic acid amide is most preferred. The stearic acid amide has the same number of carbons as the oleic amide that is most desirably used, and is considered to be capable of being most stably distributed in the multiplicity of molecular layers formed by the oleic amide.

In the present invention, the unsaturated aliphatic amide and the saturated aliphatic amide are added to the polyolefin resin forming the inner surface layer of the container in a total amount in a range described above or, concretely, in an amount of not less than 500 ppm but less than 4000 ppm and, particularly, 500 to not larger than 3000 ppm.

It is, further, desired that the unsaturated aliphatic amide and the saturated aliphatic amide are used at a weight ratio of 1:0.1 to 1:4 and, particularly, 1:0.2 to 1:4. Upon using them at the above ratio, molecules of the saturated aliphatic amide are homogeneously distributed in the multiplicity of molecular layers having highly cleaving property formed by the unsaturated aliphatic amide and, accordingly, thermally stabilizing effect is exhibited by the saturated aliphatic amide to a maximum degree.

As will be understood from the above description, the present invention uses the oleic amide and erucic amide as the unsaturated aliphatic amides and uses the stearic acid amide as the saturated aliphatic amide making it possible to most effectively avoid a decrease in the inverted fall-down performance caused by thermal hysteresis.

### <Organic Peroxides>

In the present invention, further, an organic peroxide is added together with the above aliphatic amide to avoid a decrease in the inverted fall-down performance caused by thermal hysteresis. As described already, the organic peroxide that is added helps develop anchoring effect, enables the multiplicity of molecular layers of the aliphatic amide to be partly and strongly fixed to the surface of the polyolefin resin layer, effectively suppresses the multiplicity of molecular layers from being peeled off by thermal hysteresis, and works to stably maintain excellent inverted fall-down performance.

As the organic peroxide, though not limited thereto only, there can be exemplified diacyl peroxides such as benzoyl peroxide, p-chlorobenzoyl peroxide, decanoyl peroxide, lauroyl peroxide and acetyl peroxide; peroxy ethers such as t-butylperoxy-2-ethyl hexanoate, t-butylperoxy dicarbonate, cumylperoxy neodecanoate and t-butylperoxy benzoate; and percarbonates such as diisopropylperoxy dicarbonate, di-2-ethylhexylperoxy dicarbonate, and di-sec-butyloxy percarbonate, which may be used alone or in two or more kinds in combination.

In the present invention, the above organic peroxide is desirably used in an amount of 10 to 70% by weight and, particularly, 10 to 30% by weight relative to the above aliphatic amide. If the amount thereof is small, the anchoring effect is not satisfactory, and the durability of inverted fall-down performance cannot be improved to a sufficient degree. Further, its use in unnecessarily large amounts simply results in a disadvantage in cost.

A packing container which comprises the above multi-layer plastic container filled with the non-oily content features excellent inverted fall-down performance. Therefore, if the packing container is held in an inverted state, even a viscous non-oily content quickly falls down toward the neck side without staying on the inner surface of the container wall. Namely, upon tilting the container, the content can be quickly taken out thoroughly without staying in the container.

The present invention conspicuously and effectively exhibits its effect to a maximum degree particularly when the container is hot-filled with viscous foods such as ketchup and the like.

When the organic peroxide is added together with the aliphatic amide, the inverted fall-down performance can be exhibited for extended periods of time.

### EXAMPLES

The present invention will now be described by way of the following Experiments.

In the following Experiments, the fall-down speed of the content was measured as described below.

### [Measuring the Fall-Down Speed]

By using a polyethylene resin (low-density polyethylene, MFR=22) as a base material resin, resin compositions were prepared by blending the resin material resin with various kinds of additives according to recipes of Experiments and were injection-molded into sample substrates measuring 92 mm (long)×92 mm (wide)×1.5 mm (thick). A ketchup (viscosity at 23° C.; 1740 cps) of an amount of 70 mg was placed on ends on one side of the sample substrates which were tilted at an angle of 85 degrees so that the ketchup rolled down (temperature; 23° C.). The roll-down behaviors of the ketchup at this moment were measured through a camera, analyzed, and roll-down speeds were calculated from the plots of moving distance and time, and were used as indexes. The larger the fall-down speed, the more excellent the inverted content fall-down performance.

### Experiment 1

Various additives were added to the polyethylene resin as shown in Table 1, and were melted and kneaded together by using a biaxial extruder. The melt-kneaded products were injection-molded to prepare sample substrates. The roll-down speeds of the ketchup were measured without subjecting the sample substrates to the thermal hysteresis. The results were as shown in Table 1.

TABLE 1

| | Blended | Roll-down |
|---|---|---|
| | amount | speed |
| Lubricant | (ppm) | (mm/min) |
| Higher fatty acid | | |
| stearic acid | 1000 | 0.3 |
| Unsaturated aliphatic amide | | |
| oleic amide | 1000 | 22.7 |
| erucic amide | 1000 | 3.9 |
| ethylenebisoleic amide | 1000 | 2.1 |
| Saturated aliphatic amide | | |
| stearyl amide | 1000 | 1.9 |
| lauryl amide | 1000 | 1.9 |
| decyl amide | 1000 | 1.3 |
| Ester of higher fatty acid | | |
| stearic acid cholesteryl | 1000 | 0.5 |
| stearic acid phenyl ester | 1000 | 0.6 |
| Anilide | | |
| stearyl anilide | 1000 | 0.1 |
| Metal soap | | |
| Ca stearate | 2500 | 0.8 |
| Paraffin | | |
| fluidized paraffin | 2500 | 0.6 |
| refined paraffin wax | 2500 | 0.2 |
| microcrystalline wax | 2500 | 0.7 |
| synthetic wax | 2500 | 0.4 |
| None (blank) | | |
| — | — | 0.2 |

It will be learned from the results of Table 1 that addition of the aliphatic amide and, particularly, the unsaturated aliphatic amide helps improve the inverted fall-down performance when not subjected to the thermal hysteresis.

### Experiment 2

Sample substrates were prepared by using the oleic amide as the additive and varying the amount of its addition per the polyethylene resin. By using the sample substrates, the roll-down speeds were measured without effecting the thermal hysteresis. FIG. 3 shows a relationship between the amount of addition and the roll-down speed.

It will be learned from the results of FIG. 3 that the roll-down speed is improved to a sufficient degree when the amount of addition is in a range of not less than 500 ppm but less than 4000 ppm. It will be, further, learned that the roll-down speed is nearly saturated when the amount of addition reaches about 3000 rpm.

### Experiment 3

Sample substrates were prepared by using various kinds of amides, and adding the amides in an amount of 1000 ppm per the polyethylene resin. The sample substrates were held in the ketchup maintained at a temperature of 85° C. for 5 seconds, taken out therefrom, and were returned back to room temperature. The surfaces thereof were washed with ion-exchanged water, dried and, thereafter, the roll-down speeds were measured. The results were as shown in Table 2.

TABLE 2

| | Roll-down speed after |
|---|---|
| | thermal hysteresis |
| Additive | (mm/min) |
| Unsaturated aliphatic amide | |
| oleic amide | 6.7 |
| erucic amide | 0.2 |
| ethylenebisoleic amide | 0.1 |
| Saturated aliphatic amide | |
| stearyl amide | 0.5 |
| lauryl amide | 0.1 |
| decyl amide | 0.1 |

It will be learned from the above results that the roll-down speed decreases through the thermal hysteresis and greatly decreases, particularly, when the unsaturated aliphatic amide is added.

### Experiment 4

Various kinds of sample substrates (1 to 10) were prepared in the same manner as in Experiment 1 by using either the oleic amide or the erucic amide as the unsaturated aliphatic amide, using a stearyl amide (stearic acid amide) as the saturated aliphatic amide, and adding them to the polyethylene resin in amounts shown in Table 3.

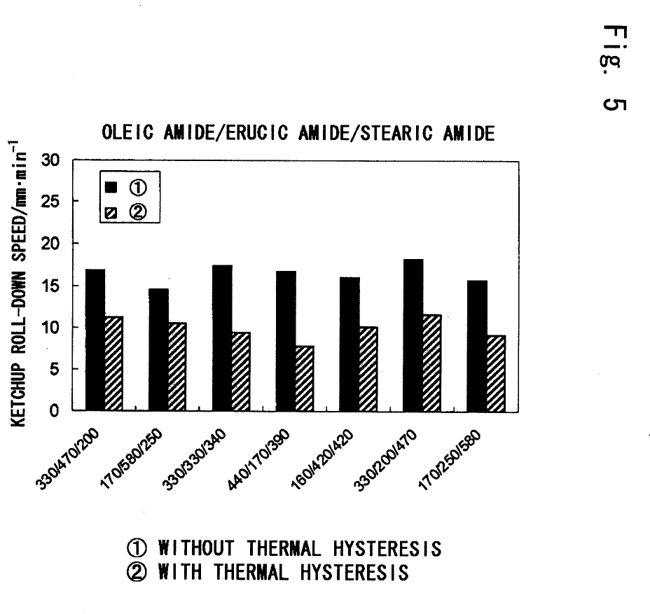

By using the sample substrates, the roll-down speeds were measured in the same manner as in Experiment 1 without effecting the thermal hysteresis. Further, the sample substrates were held in the ketchup maintained at a temperature of 85° C. for 5 seconds in the same manner as in Experiment 3, taken out therefrom, and were returned back to room temperature. The surfaces thereof were washed with ion-exchanged water, dried and, thereafter, the roll-down speeds were measured. The results were as shown in Table 3 and in graphs of FIGS. 4(a) and (b).

TABLE 3

| | | | Saturated | Roll-down speed | Roll-down speed |
|---|---|---|---|---|---|
| | Unsaturated aliphatic amide | | aliphatic amide | (without thermal | (with thermal |
| Sample | Oleic amide | Erucic amide | Stearyl amide | hysteresis) | hysteresis) |
| No. | (ppm) | (ppm) | (ppm) | (mm/min) | (mm/min) |
| 1 | 800 | 0 | 200 | 24.5 | 8.2 |
| 2 | 700 | 0 | 300 | 21.8 | 7.7 |
| 3 | 500 | 0 | 500 | 20.5 | 8.3 |
| 4 | 300 | 0 | 700 | 21.0 | 6.3 |
| 5 | 200 | 0 | 800 | 21.0 | 5.6 |
| 6 | 0 | 800 | 200 | 6.5 | 3.4 |
| 7 | 0 | 700 | 300 | 7.4 | 3.8 |
| 8 | 0 | 500 | 500 | 5.7 | 2.9 |
| 9 | 0 | 300 | 700 | 5.0 | 3.2 |
| 10 | 0 | 200 | 800 | 6.8 | 1.2 |

It will be learned from the above results that use of the saturated aliphatic amide in addition to the unsaturated aliphatic amide helps improve the roll-down speed after the thermal hysteresis and avoid a decrease in the roll-down speed caused by thermal hysteresis. Here, the roll-down speeds of the samples 4 and 5 to which the oleic amide and the stearyl amide have been added of Table 3 after the thermal hysteresis, are smaller than the roll-down speed of the sample substrate to which the oleic amide has been added in an amount of 1000 ppm of Table 2 after the thermal hystereis. It will, therefore, be learned that use of the stearyl amide in addition to the oleic amide makes small the amount of decrease in the roll-down speed.

### Experiment 5

Various kinds of sample substrates (1 to 9) were prepared in the same manner as in Experiment 1 by using both the oleic amide and the erucic amide as the unsaturated aliphatic amides, using the stearyl amide (stearic acid amide) as the saturated aliphatic amide, and adding them to the polyethylene resin in amounts shown in Table 4.

By using the sample substrates, the roll-down speeds were measured in the same manner as in Experiment 1 without effecting the thermal hysteresis. Further, the sample substrates were held in the ketchup maintained at a temperature of 85° C. for 5 seconds in the same manner as in Experiment 3, taken out therefrom, and were returned back to room temperature. The surfaces thereof were washed with ion-exchanged water, dried and, thereafter, the roll-down speeds were measured. The results were as shown in Table 4 and in a graph of FIG. 5.

TABLE 4

| | | | Saturated | Roll-down speed | Roll-down speed |
|---|---|---|---|---|---|
| | Unsaturated aliphatic amide | | aliphatic amide | (without thermal | (with thermal |
| Sample | Oleic amide | Erucic amide | Stearyl amide | hysteresis) | hysteresis) |
| No. | (ppm) | (ppm) | (ppm) | (mm/min) | (mm/min) |
| 1 | 330 | 470 | 200 | 16.9 | 11.2 |
| | | total/800 | | | |
| 2 | 170 | 580 | 250 | 14.7 | 10.5 |
| | | total/750 | | | |
| 3 | 330 | 330 | 340 | 17.4 | 9.5 |
| | | total/660 | | | |
| 4 | 440 | 170 | 390 | 16.8 | 7.9 |
| | | total/610 | | | |
| 5 | 160 | 420 | 420 | 16.8 | 10.1 |
| | | total/580 | | | |
| 6 | 330 | 200 | 470 | 18.3 | 11.7 |
| | | total/530 | | | |
| 7 | 170 | 250 | 580 | 15.6 | 9.2 |
| | | total/420 | | | |

It will be learned from the above results that the substrates of the three-component type using the oleic amide and the erucic amide as the unsaturated aliphatic amides in combination with the saturated aliphatic amide, exhibit improved the roll-down speeds after the thermal hysteresis maintaining the highest stability and are most effective in avoiding a decrease in the roll-down speed caused by thermal hysteresis.

### Experiment 6

Sample substrates were prepared by adding the oleic amide and an organic peroxide (Perhexine 25B-40, manufactured by Nihon Yushi Co.) in amounts as shown in Table 5 per the polyethylene resin of the base member. The substrates were dipped in hot water maintained at a temperature of 85° C. for 30 seconds. Thereafter, the roll-down speeds were measured and were compared with the roll-down speeds of before being treated with hot water. The results were as shown in Table 5.

TABLE 5

| | | Roll-down speed | Roll-down speed |
|---|---|---|---|
| | Organic | before treated | after treated |
| Oleic amide/ | peroxide/ | with hot water | with hot water |
| ppm | ppm | (mm/min) | (mm/min) |
| 1000 | 0 | 22.68 | 11.96 |
| 1000 | 300 | 17.69 | 18.62 |
| 1000 | 1000 | 18.23 | 17.35 |

It will be learned from the above results that the roll-down speed decreases through the thermal hysteresis when no organic peroxide is added. Upon adding the organic peroxide, however, it is allowed to avoid a decrease in the roll-down speed caused by thermal hysteresis or to improve the roll-down speed. That is, even when exposed to high temperatures, it is confirmed that addition of the organic peroxide makes it possible to stably maintain a multiplicity of molecular layers of the aliphatic amide formed by bleeding.

1. A multi-layer plastic container for a non-oily content having at least a polyolefin resin layer on an inner surface thereof and for being filled with the non-oily content, wherein the polyolefin resin layer on the inner surface of the container contains an aliphatic amide in an amount of not less than 500 ppm but less than 4000 ppm.

2. The multi-layer plastic container according to claim 1, wherein at least part of said aliphatic amide is an unsaturated aliphatic amide.

3. The multi-layer plastic container according to claim 2, wherein said unsaturated aliphatic amide has carbons in a number in a range of 14 to 24.

4. The multi-layer plastic container according to claim 3, wherein said unsaturated aliphatic amide is an oleic amide.

5. The multi-layer plastic container according to claim 1, wherein said polyolefin resin layer is, further, blended with an organic peroxide.

6. The multi-layer plastic container according to claim 2, wherein said polyolefin resin layer is blended with an unsaturated aliphatic amide and a saturated aliphatic amide as said aliphatic amide.

7. The multi-layer plastic container according to claim 6, wherein said unsaturated aliphatic amide and the saturated aliphatic amide are blended at a weight ratio of 1:0.1 to 1:4.

8. The multi-layer plastic container according to claim 6, wherein at least two kinds of amides of oleic amide and erucic amide are contained as the unsaturated aliphatic amide.

9. The multi-layer plastic container according to claim 6, wherein said saturated aliphatic amide is a stearic acid amide.

10. The multi-layer plastic container according to claim 1, wherein the polyolefin resin layer on the inner surface of the container is a polyethylene resin layer.

11. A packing body wherein the multi-layer plastic container of claim 1 is hot-filled with a non-oily content.

12. The packing body according to claim 11, wherein said non-oily content is a viscous food.

13. The packing body according to claim 12, wherein said viscous food is ketchup.
